(19) United States
(12) Patent Application Publication
(10) Pub. No.: US 2026/0315847 A1
(43) Pub. Date: Oct. 15, 2026

(54) SPRINKLER HEAD

(71) Applicant: SENJU SPRINKLER CO., LTD., Tokyo (JP)

(72) Inventor: Yasuaki KOIWA, Tokyo (JP)

(73) Assignee: SENJU SPRINKLER CO., LTD., Tokyo (JP)

(21) Appl. No.: 19/486,176

(22) PCT Filed: Jun. 28, 2023
(86) PCT No.: PCT/JP2023/024065

§ 371 Date: Nov. 20, 2025

(51) Int. Cl. A62C 31/02

(52) U.S. Cl. CPC A62C 31/02

(57) ABSTRACT

The sprinkler head 1 comprises: a main body having a nozzle for discharging fire-extinguishing liquid; a valve body for closing the outlet of the nozzle; a deflector having a water sprayed surface with which the fire-extinguishing liquid discharged from the nozzle comes into contact; and an arm plate as a “first diverting plate piece” supporting the deflector. The arm plate has a plate piece shape with its plate surface rising vertically from the water sprayed surface toward the main body, divides the water sprayed surface into a plurality of surfaces, and diverts the fire-extinguishing liquid into flows directed toward the plurality of surfaces.

### TECHNICAL FIELD

The present disclosure relates to a sprinkler head.

### BACKGROUND ART

As a type of sprinkler head, a sidewall sprinkler head installed on a sidewall of a building is known (Patent Document 1). “Sidewall” means a wall along a vertical direction intersecting with a floor and a ceiling of a building. Sidewall sprinkler heads are installed at positions near the ceiling of the sidewall and are required to disperse fire-extinguishing liquid over a wide protection region from a far region away from the sidewall to a near region close to the sidewall, making water spray control particularly difficult.

### CITATION LIST

### Patent Literature

PTL 1: Japanese Unexamined Patent Application Publication No. 2019-170479

### SUMMARY OF INVENTION

### Technical Problem

Therefore, the present disclosure aims to provide a technology that can appropriately spray water over a protection region.

### Solution to Problem

(1) One aspect of the present disclosure is a sprinkler head comprising: a main body having a nozzle for discharging fire-extinguishing liquid; a valve body for closing an outlet of the nozzle; a deflector having a water sprayed surface with which the fire-extinguishing liquid discharged from the nozzle comes into contact; and a first diverting plate piece supporting the deflector, wherein the first diverting plate piece has a plate piece shape with its plate surface rising vertically from the water sprayed surface toward the main body, divides the water sprayed surface into a plurality of surfaces, and diverts the fire-extinguishing liquid into flows directed toward the plurality of surfaces.

Since the first diverting plate piece supporting the deflector has a plate piece shape, when the fire-extinguishing liquid discharged from the nozzle contacts the first diverting plate piece, reduction in the momentum of the flow of the fire-extinguishing liquid can be suppressed. The first diverting plate piece divides the water sprayed surface into a plurality of surfaces and diverts the fire-extinguishing liquid into flows directed toward the plurality of surfaces. Therefore, by diverting the fire-extinguishing liquid while maintaining the momentum of the fire-extinguishing liquid discharged from the nozzle as much as possible, the fire-extinguishing liquid can be appropriately dispersed over the protection region.

The first diverting plate piece has a plate edge surface on the nozzle side arranged along an imaginary line passing through an upper end, a center of the axis, and a lower end of the nozzle.

According to this, the first diverting plate piece can divert the columnar fire-extinguishing liquid discharged from the nozzle to both sides of the first diverting plate piece without bias.

(2) The first diverting plate piece has a first mounting portion for mounting to the deflector, and the deflector has a first mounting receiver portion for mounting the first mounting portion.

According to this, the first diverting plate piece and the deflector can be configured as an integral assembly.

(3) The first diverting plate piece has a projecting portion that projects toward the valve body and that receives a closing load of the valve body against the nozzle. The projecting portion has its tip positioned on the center of the axis of the nozzle.

According to this, a function of receiving the closing load of the valve body that closes the nozzle can be added to the projecting portion of the first diverting plate piece having a function of diverting the fire-extinguishing liquid. Further, according to the configuration where the tip of the projecting portion is positioned on the center of the axis of the nozzle, it can contact the center of the valve body positioned on the center of the axis of the nozzle and can receive the closing load within the range of the plate thickness of the first diverting plate piece.

(4) The first diverting plate piece has an inclined arm piece, and the inclined arm piece extends obliquely downward in a direction approaching from the deflector side toward the main body side. The inclined arm piece may be disposed below the center of the axis.

The fire-extinguishing liquid is discharged from the nozzle in a water column shape. The tip of the water column shape of the fire-extinguishing liquid gradually contacts from the lower end side (main body side) to the upper end side (deflector side) of the inclined arm piece. In other words, the water column gradually contacts the inclined arm piece from its outer peripheral surface side toward the center side. As a result, the outer peripheral surface side of the water column of the fire-extinguishing liquid scatters forward and downward, and the forward flight distance can be gradually extended from the outer peripheral surface side toward the center side of the water column. In this way, the inclined arm piece can gradually divert the fire-extinguishing liquid to the left and right of the inclined arm piece.

(5) The first diverting plate piece has a vertical arm piece, and the vertical arm piece extends upward vertically to the center of the axis. The inclined arm piece may be disposed above the center of the axis.

The water column shaped fire-extinguishing liquid can be dispersed forward while being diverted to the left and right of the vertical arm piece by contacting the vertical arm piece.

(6) Further, the sprinkler head has a guide pin for movably supporting the deflector along the axial direction of the nozzle, and the first diverting plate piece has a pin holder which is movably engaged with the guide pin. The guide pin and the pin holder may each be one or plural.

According to this, since the deflector can be moved forward when the sprinkler head operates, the fire-extinguishing liquid discharged from the nozzle can be dispersed at a position close to the protection region.

(7) Further, the sprinkler head comprises a second diverting plate piece, wherein the second diverting plate piece has a plate piece shape with its plate surface rising vertically from the water sprayed surface toward the main body in a state intersecting with the first diverting plate piece, and diverts the fire-extinguishing liquid discharged from the nozzle.

According to this, since the second diverting plate piece has a plate piece shape, when the fire-extinguishing liquid discharged from the nozzle contacts the second diverting plate piece, reduction in the momentum of the flow of the fire-extinguishing liquid can be suppressed. Since the second diverting plate piece is arranged with its plate surface intersecting with the first diverting plate piece, the fire-extinguishing liquid can be further diverted. Thereby, the fire-extinguishing liquid can be more appropriately dispersed over the protection region.

(8) At least one of the first diverting plate piece or the second diverting plate piece has a contact portion that abuts the valve body and receives the closing load of the valve body against the nozzle.

According to this, the closing load for closing the nozzle can be reliably received by the contact portion of at least one of the first diverting plate piece or the second diverting plate piece.

(9) The second diverting plate piece has a second mounting portion for mounting to the deflector, and the deflector has a second mounting receiver portion for mounting the second mounting portion.

According to this, the second diverting plate piece can be configured as an integral assembly with the deflector.

(10) The first diverting plate piece and the second diverting plate piece are each formed from a metal plate and constitute a cross-lap joint assembly.

According to this, the first diverting plate piece and the second diverting plate piece can be realized with a simple structure and at low cost by sheet metal working. Further, since it is a cross-lap joint assembly, the rigidity of the first diverting plate piece and the second diverting plate piece can be enhanced. Therefore, even when a large closing load is applied for a long period, the outlet of the nozzle can be stably sealed by the valve body. Furthermore, since it is a cross-lap joint assembly, it can be easily assembled.

(11) The first diverting plate piece and the second diverting plate piece may have semicircular shapes. The maximum plate width of the second diverting plate piece may be formed wider than the maximum plate width of the first diverting plate piece.

Since the first diverting plate piece and the second diverting plate piece are semicircular, they can gradually contact the fire-extinguishing liquid discharged from the nozzle. Therefore, rapid reduction in the momentum of the flow of the fire-extinguishing liquid can be prevented. Further, the present inventor compared the dispersing performance of the fire-extinguishing liquid between cases where the maximum plate width of the second diverting plate piece and the maximum plate width of the first diverting plate piece are the same, and where the maximum plate width of the second diverting plate piece is made larger than the maximum plate width of the first diverting plate piece. As a result, it was found that by providing a difference in maximum plate width, the fire-extinguishing liquid can be dispersed more widely by the diverting plate piece having a larger maximum plate width. Thus, by making the maximum plate width of the second diverting plate piece larger than that of the first diverting plate piece, the fire-extinguishing liquid can be dispersed over a wider protection region.

(12) The deflector has: a plate-shaped deflector main body vertical to the center of the axis of the nozzle; an assist deflector disposed above the deflector main body; a connection piece portion connecting the deflector main body and the assist deflector; and a water flow opening portion formed between the deflector main body, the assist deflector, and the connection piece portion.

According to this, the deflector main body can disperse the fire-extinguishing liquid mainly in the near region on the wall side where the sprinkler head is installed. Further, by the assist deflector rectifying the fire-extinguishing liquid that has passed through the water flow opening portion, the fire-extinguishing liquid can be dispersed mainly in the far region away from the wall where the sprinkler head is installed.

(13) The deflector main body has a rectifying projection projecting toward the water flow opening portion, and the rectifying projection has a top wider than the plate thickness of the end face of the deflector-side plate end of the first diverting plate piece, and a foot portion where a ridgeline extending from the top curves in a concave shape.

The rectifying projection rectifies the water flow that passes through the first diverting plate piece and flows to the water flow opening portion. Specifically, since the rectifying projection has a top wider than the plate thickness of the end face of the deflector-side plate end of the first diverting plate piece, it can suppress the fire-extinguishing liquid diverted by the first diverting plate piece from converging and can diffuse the fire-extinguishing liquid forward. Further, since the rectifying projection has the foot portion where the ridgeline extending from the top curves in a concave shape, the fire-extinguishing liquid diverted by the first diverting plate piece (the fire-extinguishing liquid flowing through the water flow opening portion) is rectified by the concavely curved foot portion, whereby the flow of each water stream can be maintained without greatly reducing the momentum of the flow of the fire-extinguishing liquid, and the forward flight distance can be secured.

### BRIEF DESCRIPTION OF DRAWINGS

To clearly explain based on embodiments exemplifying one aspect of the present disclosure, the drawings necessary for the explanation will be briefly described. The drawings merely exemplify embodiments and are not intended to limit the scope of the embodiments of the present disclosure. Those skilled in the art can obtain drawings of other related embodiments based on the drawings of the present disclosure without using special inventive ability.

FIG. 1 is a right side view of a sidewall sprinkler head according to an embodiment.

FIG. 2 is a front view of the sidewall sprinkler head of FIG. 1.

FIG. 3 is an explanatory diagram showing the installed state of the sidewall sprinkler head along the III-III line cross-section of FIG. 2.

FIG. 4 is an explanatory diagram showing the operating state of the sidewall sprinkler head.

FIG. 5 is an external perspective view of support members and a deflector according to an embodiment.

FIG. 6 is an exploded perspective view of a deflector according to an embodiment.

FIG. 7 is a rear view of the deflector viewed from the rear side of the sidewall sprinkler head.

FIG. 8 is a partially enlarged view of part VIII of FIG. 7.

FIG. 9 is a front view of the deflector viewed from the front side of the sidewall sprinkler head.

FIG. 10 is a schematic diagram showing the rectification of the deflector in right side view.

FIG. 11 is a schematic diagram showing the rectification of the deflector in bottom view.

FIG. 12 is a schematic diagram showing the rectification of the deflector in rear view.

FIG. 13 is a schematic diagram showing the rectification of the deflector in front view.

FIG. 14 is an explanatory diagram schematically showing the dispersing state of fire-extinguishing liquid by the sprinkler head of FIG. 1, showing the dispersing state of only the right half in front of the sprinkler head.

### DESCRIPTION OF EMBODIMENTS

Hereinafter, one aspect of the present disclosure will be described based on embodiments with reference to the drawings. The following embodiments do not limit the description of the claims, and all configurations provided in the present embodiments are not necessarily essential as solutions according to the present disclosure.

All embodiments and selectable embodiments included in the present disclosure may be combined with each other to form new embodiments. Further, all technical features and selectable technical features included in the present disclosure can form new technical features by being combined with each other.

The term “or” used in the present specification and claims is used as an inclusive term. For example, “A or B” means “A, B, or both A and B”. “A”, “B”, and “both A and B” each satisfy “A or B”.

In the present specification and appended claims, the terms such as “to mount”, “to join”, “to connect”, or “to fix” are used in their broader senses unless otherwise indicated clearly and specifically. For example, the term “to connect” includes “to fixedly connect”, “to removably connect”, “to detachably connect”, or “to integrally connect”. Moreover, the term “to connect” encompasses direct connection without any element interposed therebetween as well as indirect connection with any element interposed therebetween. In the present disclosure, those skilled in the art are expected to interpret the meanings of the above terms with reference to actual situations in which the terms are used.

In the present specification and appended claims, terms such as “first” and “second” are not used to imply a specific order nor superiority/inferiority but used to differentiate elements from one another. Elements commonly used in different embodiments and having the same advantageous effects are denoted by the same reference signs, and duplicated descriptions will be omitted.

In the present specification and appended claims, terms to describe directional and spatial relationships, such as “center”, “vertical direction”, “horizontal direction”, “length”, “width”, “thickness”, “up”, “down”, “front”, “rear”, “left”, “right”, “vertical”, “horizontal”, “top”, “bottom”, “inside”, “outside”, “clockwise”, “counterclockwise”, “axial direction”, “radial direction”, or “circumferential direction”, are to be interpreted with reference to the drawings. These terms are used for the purpose of describing embodiments briefly and conveniently. Unless otherwise defined or specified clearly, these terms are not intended explicitly or implicitly to limit the orientation of a specific element when such an element is disposed or used nor to limit the scope of the present disclosure set forth in the claims.

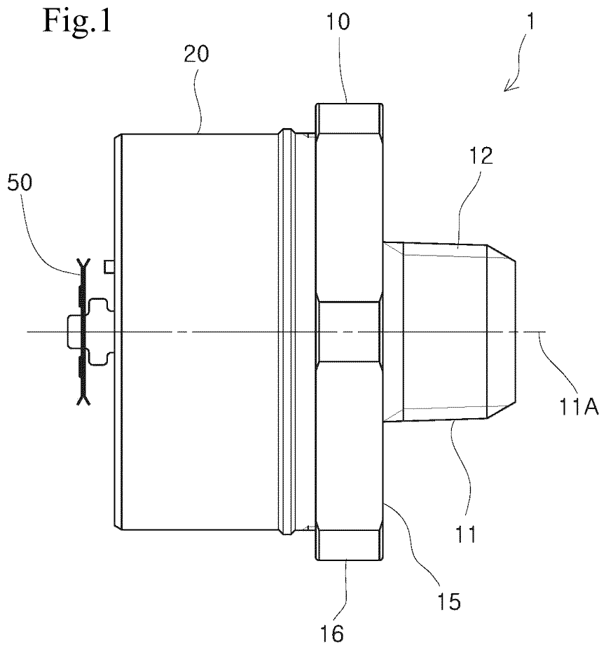

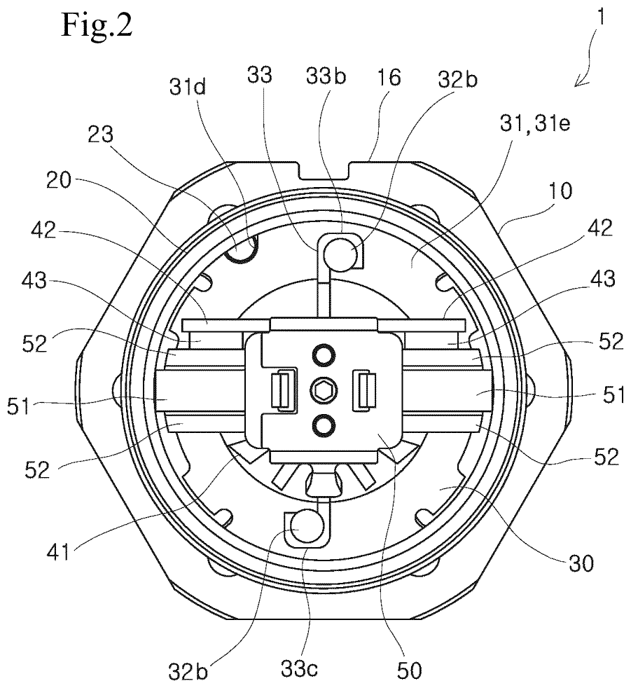

In the present specification and appended claims, based on FIG. 1 showing the right side view of the sprinkler head, the right side of FIG. 1 will be described as “rear”, the left as “front”, the top as “top”, and the bottom as “bottom”. Further, based on the front view of the sprinkler head shown in FIG. 2, the right side of FIG. 2 will be described as “right”, the left as “left”, the top as “top”, and the bottom as “bottom”. Therefore, at the center of the axis of the sprinkler head (see reference sign 11A in FIG. 1), the direction from the nozzle toward the deflector side is “front side”, “forward”, “room-side”, and the direction from the deflector toward the nozzle side is “rear side”, “rearward”, “outside the room”.

When terms such as “about”, “approximately”, and “substantially” are used in the present specification and appended claims, numerical values, structural elements, and positions with these terms can be understood to include the numerical value and numerical values before and after centered on that numerical value, to include the structural element and elements that can be said to be the same as that structural element, and to include specific positions and spatial relationships that can be regarded as the same, respectively. For example, when described as “about 3”, values before and after that may be included in “about 3” as long as they have the technical features and technical significance claimed in the present disclosure. Further, when “B substantially identical to A”, in addition to cases where B is completely identical to A, structural elements that are not completely identical but have differences may be included in the scope of “substantially” as long as they have the technical features and technical significance claimed in the present disclosure. Furthermore, when “A and B are in substantially the same position”, in addition to cases where the positions of A and B completely coincide, cases where the spatial relationship is partially shifted may also be included in “the same position”.

Hereinafter, one form of the present disclosure will be described by exemplifying embodiments of a sprinkler head. In the following embodiments, a sidewall sprinkler head is exemplified as the sprinkler head. Furthermore, the exemplified sidewall sprinkler head is a concealed type sidewall sprinkler head.

### Description of Sidewall Sprinkler Head 1

The sidewall sprinkler head 1 (hereinafter also referred to as “sprinkler head 1”) comprises a sprinkler head main body 10 (hereinafter also referred to as “main body 10”), a frame 20, support members 30, a deflector 40, a heat-sensitive member 50, an urging member 60, and a cover member 70.

As shown in FIGS. 1 to 3, the cover member 70 installed on the front side (room-side) of the sidewall W of a building is connected to the frame 20. The frame 20 is connected to the main body 10. The main body 10 supports the deflector 40 via the support member 30.

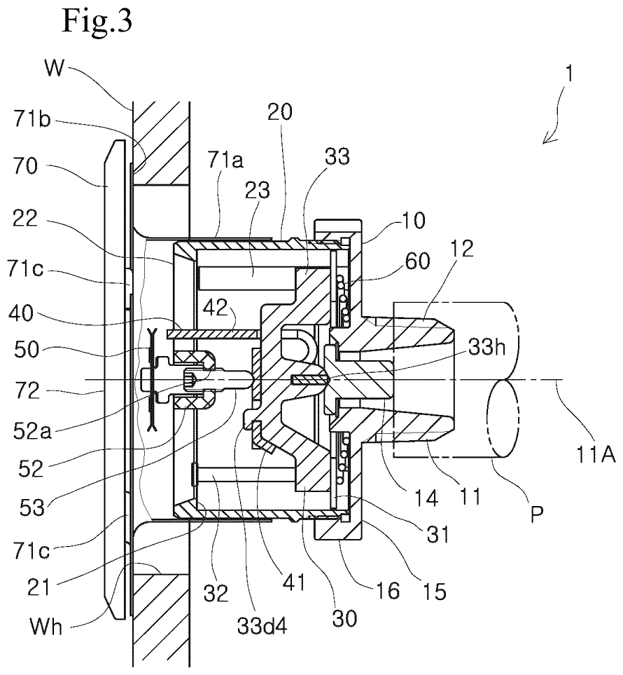

As shown in FIG. 3, the sidewall sprinkler head 1 is installed with the heat-sensitive member 50 positioned in an opening Wh formed in the sidewall W, and the cover member 70 is installed to cover and hide the opening Wh.

### Main Body 10

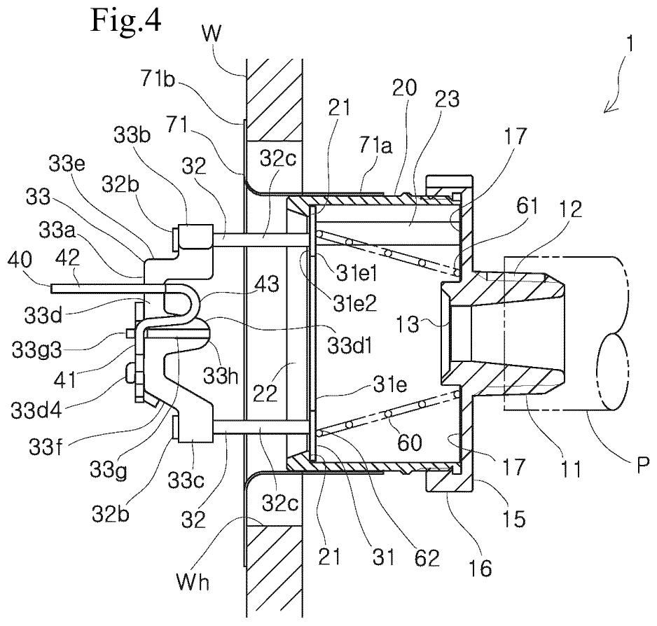

The main body 10 has a nozzle 11. The nozzle 11 has a tubular shape, and a first end of the nozzle 11 is connected to a water pipe P installed on the back side (outside the room) of the sidewall W. The outer peripheral surface of the first end of the nozzle 11 forms a male thread 12 for connection to the water pipe P. A second end of the nozzle 11 is on the opposite side of the first end and forms an outlet 13 for discharging fire-extinguishing liquid (FIG. 4). The outlet 13 is formed in a short tubular shape projecting from a flange portion 15 of the main body 10. The outlet 13 projects from the flange portion 15 shorter than a connection portion 16 described later. As shown in FIG. 4, an accommodation recess 17 is formed between the tubular outlet 13 and the connection portion 16. As shown in FIG. 3, the urging member 60 is accommodated in the accommodation recess 17. Furthermore, the inner diameter of a guide ring 31 described later is larger than the outer diameter of the tubular outlet 13. Thereby, the accommodation recess 17 is configured to be able to accommodate the guide ring 31 as well. The nozzle 11 (outlet 13) is normally closed by a valve body 14 when the sidewall sprinkler head 1 is not operating.

The main body 10 has a flange portion 15. The flange portion 15 is formed between the outlet 13 (second end) and the male thread 12 (first end) of the nozzle 11. The flange portion 15 has an annular shape. A connection portion 16 is formed on the outer edge of the flange portion 15. The connection portion 16 is formed in a cylindrical shape, and its tube axis coincides with the center of the axis 11A of the nozzle 11. A female thread is formed inside the connection portion 16. The female thread is configured to be screwable with a male thread formed on one end (outer peripheral surface of the main body side end) of the frame 20. The connection portion 16 and the frame 20 form an integral structure by being connected through the screwing of the female thread and male thread.

### Frame 20

The frame 20 is formed in a cylindrical shape. The support member 30, deflector 40, and heat-sensitive member 50 are accommodated in the frame 20. A step 21 is formed on the inner peripheral surface of the front end side of the frame 20. The step 21 is provided at the front end of the frame 20, that is, at an open end 22, and is formed to project inward. The step 21 is formed over the entire circumference of the inner peripheral surface of the frame 20. The step 21 is formed as an engagement step portion where a pair of levers 51 of the heat-sensitive member 50 described later engage during normal times. On the other hand, the step 21 is formed as an engagement step portion where the guide ring 31 of the support member 30 described later engages when the sidewall sprinkler head 1 operates.

The inner peripheral surface of the frame 20 has a guide portion 23. The guide portion 23 of this embodiment is a projection, but is not limited to this. That is, the guide portion 23 according to one modification can be configured as a recess that guides the movement of a projection provided on the guide ring 31. The guide portion 23 of this embodiment has a semicylindrical shape projecting toward the center of the axis 11A, and is formed in a linear shape with its pillar axis direction and longitudinal direction extending parallel to the center of the axis 11A of the nozzle 11. The guide portion 23 is provided to correctly guide the movement (forward movement in the direction of the center of the axis 11A) of the guide ring 31 described later when the sidewall sprinkler head 1 operates. The guide portion 23 of this embodiment is provided at one location in the circumferential direction of the inner peripheral surface of the frame 20, but the form of the guide portion 23 is not limited to this. That is, the guide portion 23 may be provided at multiple locations in the circumferential direction of the inner peripheral surface of the frame 20.

### Support Member 30

The support member 30 comprises a guide ring 31, pins 32, and an arm plate 33. In the support member 30, the guide ring 31 and pins 32 are fixed, and the arm plate 33 is configured to be movable relative to the pins 32.

### <Guide Ring 31>

The guide ring 31 in this embodiment is constituted by a press molding body of a metal thin plate, but is not limited to this. That is, the guide ring 31 can be constituted by a rigid resin molding body. The guide ring 31 has an annular shape, and its inner peripheral portion 31a is formed as an accommodation hole of a size capable of arranging the valve body 14.

A guide piece 31c is formed on an outer peripheral portion 31b of the guide ring 31. The guide piece 31c is formed as a bent piece formed by bending the outer peripheral portion 31b of the guide ring 31 toward the main body 10. The guide piece 31c is formed at four locations on the outer peripheral portion 31b in this embodiment, but is not limited to this. That is, the guide piece 31c can be configured as one or plural.

A guide receiver portion 31d into which the aforementioned guide portion 23 of the frame 20 enters is formed on the outer peripheral portion 31b. The guide receiver portion 31d is formed as a recess formed by cutting out the outer peripheral portion 31b in a shape corresponding to the outer shape of the guide portion 23. In this embodiment, it is a semicircular recess. The guide receiver portion 31d is formed at one location in this embodiment, but is not limited to this. That is, similar to the aforementioned guide portion 23 of the frame 20, the guide receiver portion 31d may be provided at multiple locations in the circumferential direction of the outer peripheral portion 31b.

A plate portion 31e is formed in the portion between the inner peripheral portion 31a and the outer peripheral portion 31b of the guide ring 31. The plate portion 31e has a first surface 31e1 on the main body 10 side and a second surface 31e2 on the deflector 40 side. Both the first surface 31e1 and the second surface 31e2 are formed as annular surfaces. The first surface 31e1 is formed as an “urging member receiver portion” that receives a guide ring side end 60a of a compression coil spring as the urging member 60 described later.

### <Pin 32>

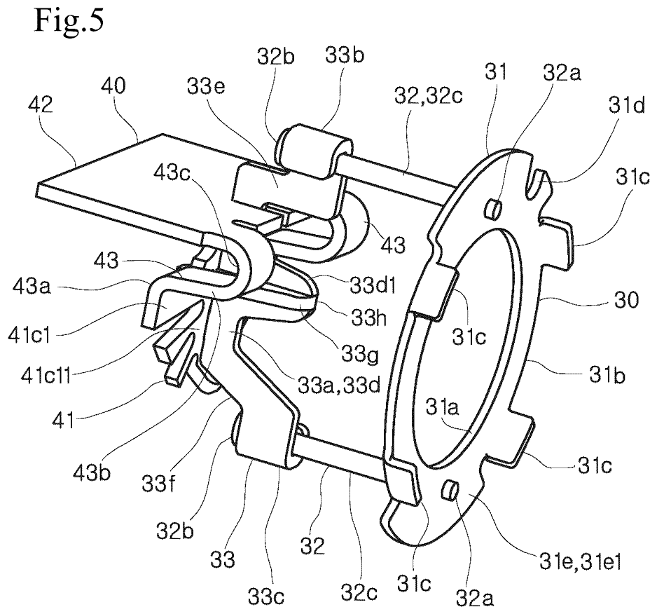

The pin 32 is, as an example, a metal round bar, and it functions as a guide pin. At the guide ring side end which is one end of the pin 32, a fixed portion 32a fixed to the plate portion 31e is formed (FIG. 5). The fixing means in the fixed portion 32a is fixed by caulking in this embodiment, but is not limited to this and may be welding or the like. A preventive portion 32b is formed at the arm plate side end which is the other end of the pin 32. The portion between the base on the fixed portion 32a side of the pin 32 projecting from the second surface 31e2 and the preventive portion 32b which is the tip of the pin 32 is formed as a pin body 32c held by pin holders (first pin holder 33b, second pin holder 33c) of the arm plate 33 described later. The pin body 32c guides the slide movement of the pin holder along its longitudinal direction.

### <Arm Plate 33>

The arm plate 33 is configured as a plate-shaped component. More specifically, the arm plate 33 of this embodiment is configured as a press molding body of a metal plate. The metal thin plate can use, for example, one of about 1.5 mm. As shown in FIG. 5, the arm plate 33 has an arm portion 33a, a first pin holder 33b, and a second pin holder 33c.

The arm portion 33a has a first plate portion 33d, a second plate portion 33e, and a third plate portion 33f. The arm portion 33a constitutes a “first diverting plate piece”. That is, the arm portion 33a as the “first diverting plate piece” has a plate shape with the plate surface rising vertically from the water sprayed surface 41c1 of the deflector 40 toward the main body 10, is arranged to divide the water sprayed surface 41c1 into a first surface 41c11 and a second surface 41c12 passing through the center of the axis 11A of the nozzle 11, and diverts the fire-extinguishing liquid discharged from the nozzle 11 into flows directed toward the first surface 41c11 and the second surface 41c12. In this embodiment, the arm portion 33a diverts the flow of fire-extinguishing liquid to the left and right.

The first plate portion 33d is formed as a “vertical arm piece” of the arm plate 33 in this embodiment. That is, the first plate portion 33d is a plate piece whose longitudinal direction is along the vertical direction (perpendicular direction) intersecting with the center of the axis 11A. Further, the first plate portion 33d has, as a “vertical arm piece”, a portion extending upward vertically to the center of the axis 11A at a position above the center of the axis 11A. The first plate portion 33d is positioned between the second plate portion 33e and the third plate portion 33f and is formed in a shape connecting them.

The first plate portion 33d has a projecting portion 33d1. More specifically, the first plate portion 33d which is the “first diverting plate piece” has a projecting portion 33d1 that projects toward the valve body 14 and receives the closing load of the valve body 14 against the nozzle 11. The projecting portion 33d1 has its tip (vertex) positioned on the center of the axis 11A of the nozzle 11. The projecting portion 33d1 is formed as a semicircular projecting piece projecting from a main body side plate end 33d2 of the first plate portion 33d. By providing the projecting portion 33d1 on the first plate portion 33d, a function of receiving the closing load of the valve body 14 that closes the nozzle 11 can be added to the “first diverting plate piece” having a function of diverting the fire-extinguishing liquid. That is, by giving multiple functions to one component, the number of parts can be reduced. Further, by the tip of the projecting portion 33d1 being positioned on the center of the axis 11A of the nozzle 11, it can contact the center of the valve body 14 positioned on the center of the axis 11A of the nozzle 11, and can apply the closing load within the range of the plate thickness of the arm plate 33 having no angle difference with respect to the center of the axis 11A.

A slit 33d3 is formed in the projecting portion 33d1. The slit 33d3 is formed as a rectangular cutout groove whose longitudinal direction is along the center of the axis 11A. A fourth plate portion 33g as a “second diverting plate piece” described later is combined with the slit 33d3.

A first mounting portion 33d4 is formed on the first plate portion 33d. The first mounting portion 33d4 is formed as a hook-shaped projecting piece projecting from a deflector side plate end 33d5 of the first plate portion 33d toward the deflector 40. More specifically, the hook-shaped projecting piece has a reverse L shape. The first mounting portion 33d4 functions as a hook for mounting the arm plate 33 to the deflector 40.

The second plate portion 33e is formed as a “horizontal arm piece” of the arm plate 33 in this embodiment. That is, the second plate portion 33e is formed so that its longitudinal direction is parallel to the center of the axis 11A. The second plate portion 33e is formed in a shape connecting the first plate portion 33d and the first pin holder 33b.

The third plate portion 33f is formed as an “inclined arm piece” of the arm plate 33 in this embodiment. That is, the third plate portion 33f is formed as an inclined piece extending in a direction intersecting with the center of the axis 11A. Further, the third plate portion 33f, as an “inclined arm piece”, extends obliquely downward at a position below the center of the axis 11A in a direction approaching from the deflector 40 side toward the main body 10 side. The third plate portion 33f is formed in a shape connecting the first plate portion 33d and the second pin holder 33c. More specifically, the third plate portion 33f is inclined to gradually move away from the center of the axis 11A from the end on the first plate portion 33d side toward the end on the second pin holder 33c side.

The arm plate 33 further has a fourth plate portion 33g. The fourth plate portion 33g constitutes a “second diverting plate piece”. That is, the fourth plate portion 33g as the “second diverting plate piece” has a plate shape rising vertically from the water sprayed surface 41c1 toward the main body 10 in a state intersecting with the water sprayed surface 41c1 of the deflector 40 and the arm portion 33a as the “first diverting plate piece”, and diverts the fire-extinguishing liquid discharged from the nozzle 11. In this embodiment, the fourth plate portion 33g diverts the flow of fire-extinguishing liquid up and down.

The fourth plate portion 33g is formed as a semiellipsoidal projecting piece projecting vertically from the deflector 40. The fourth plate portion 33g is an independent component separate from the arm plate 33 and the deflector 40, and is provided as a “boss plate”. The fourth plate portion 33g is formed as a press molding body of a metal plate. More specifically, it is formed as a boss made of a metal flat plate. The vertex of the fourth plate portion 33g is formed to be positioned on the center of the axis 11A of the nozzle 11. A slit 33g1 is formed in the fourth plate portion 33g. The slit 33g1 is formed as a rectangular cutaway groove whose longitudinal direction is along the center of the axis 11A. Both side portions of this slit 33g1 are formed as a pair of boss arms 33g2.

Further, at the tips of the pair of boss arms 33g2, there is a second mounting portion 33g3 for mounting to the deflector 40. The second mounting portion 33g3 is formed as a projecting piece projecting in a linear shape toward the deflector 40 on both sides of the slit 33g1. After being inserted into the second mounting receiver portion 41c3, the second mounting portion 33g3 is bent into a hook shape to sandwich the plate edge of the second mounting receiver portion 41c3, thereby preventing it from falling off. More specifically, the hook-shaped projecting piece has an L shape. The second mounting portion 33g3 functions as a hook for mounting the fourth plate portion 33g and the arm plate 33 to the deflector 40.

The aforementioned first plate portion 33d (first diverting plate piece) and the fourth plate portion 33g (second diverting plate piece) are combined so that their plate surfaces intersect with each other, thereby constituting a pressure receiving projection 33h that receives the closing load of the valve body 14 against the outlet 13 of the nozzle 11. More specifically, after aligning the positions of the slit 33g1 and the slit 33d3, the fourth plate portion 33g is inserted into the first plate portion 33d. Thereby, the pressure receiving projection 33h is configured as a cross-lap joint assembly combining the fourth plate portion 33g and the first plate portion 33d. By making such an assembly, the rigidity of the pressure receiving projection 33h can be enhanced. More specifically, even when a large closing load of the valve body 14 is applied for a long period, it can have strength such that the pressure receiving projection 33h does not buckle. Therefore, it is not necessary to use bolts or cast metal as used in the conventional technology described later as the pressure receiving projection 33h, and for example, a metal plate can be used. Further, since it is an assembly that becomes integral by aligning the positions of the slit 33g1 and the slit 33d3, the pressure receiving projection 33h can be easily assembled with necessary accuracy. The material of the metal plate can specifically exemplify phosphor bronze, and its plate thickness can use, for example, one of 1.0 to 3.0 mm. Both the arm plate 33 and the fourth plate portion 33g can be manufactured at low cost by sheet metal working.

In this embodiment, an example is shown in which the pressure receiving projection 33h has the fourth plate portion 33g and the first plate portion 33d, and the fourth plate portion 33g and the first plate portion 33d have a shape that extends radially in four directions around the center of the axis 11A of the nozzle 11 (a radial shape in multiple directions). However, the shape of the pressure receiving projection 33h may be a radial shape combining plate pieces directed in multiple directions other than four directions, specifically in two directions, three directions, five or more directions.

In the conventional technology, members that receive the closing load of the valve body are generally formed by bolts or cast metal because they need rigidity capable of receiving the closing load. For example, when providing a cylindrical pressure receiving projection as a member that receives the closing load of the valve body, it is formed by steel bolts or cast metal capable of supporting the closing load over many years. The pressure receiving projection has its central axis coinciding with the center of the axis of the nozzle, and the tip that contacts the valve body is formed as a hemispherical spherical surface. However, such a pressure receiving projection has a large thickness in the perpendicular direction to the center of the axis 11A of the nozzle 11. That is, the diameter of the pressure receiving projection becomes larger than the diameter of the cylindrical fire-extinguishing liquid discharged from the nozzle 11. Then, the momentum of the flow of the cylindrical fire-extinguishing liquid discharged from the nozzle 11 is weakened by the pressure receiving projection, making it difficult to extend the flight distance of the fire-extinguishing liquid.

Similarly, in the conventional technology, for example, a pair of support arms (support members) extending from the main body toward the deflector side may be provided to support the pressure receiving projection and the deflector relative to the main body of the sprinkler head. Since such support arms are generally formed by cast metal as parts of the main body, the support arms are formed thick-walled due to manufacturing constraints. Therefore, similar to the aforementioned pressure receiving projection, such support arms also become one cause of weakening the momentum of the flow when the fire-extinguishing liquid hits them. Thus, in the conventional technology, it becomes difficult to appropriately spray water over the protection region.

As described above, in the conventional technology, when the pressure receiving projection and support members are constituted by cast metal or the like, since they are large relative to the fire-extinguishing liquid discharged from the nozzle, it is difficult to appropriately disperse the fire-extinguishing liquid over the protection region.

In contrast, the pressure receiving projection 33h (the first plate portion 33d (first diverting plate piece) and the fourth plate portion 33g (second diverting plate piece)) has a shape in which plate pieces extend radially. Therefore, the pressure receiving projection 33h has a smaller contact area with the cylindrical fire-extinguishing liquid discharged from the nozzle 11 compared to a cylindrical pressure receiving projection. That is, in the pressure receiving projection 33h, the plate edge surfaces of the first plate portion 33d and the fourth plate portion 33g contact the discharged cylindrical fire-extinguishing liquid. The plate edge surface corresponds to the plate thickness of the metal plate constituting the first plate portion 33d and the fourth plate portion 33g. Therefore, the pressure receiving projection 33h can significantly reduce the contact area with the discharged fire-extinguishing liquid compared to the pressure receiving projection and support arms of the aforementioned conventional technology. Therefore, the pressure receiving projection 33h can suppress the reduction in the momentum of the flow of the fire-extinguishing liquid and can facilitate extending the flight distance of the fire-extinguishing liquid.

Further, the pressure receiving projection 33h divides the water sprayed surface 41c1 of the deflector 40 described later into a first surface 41c11 and a second surface 41c12 so as to pass through the center of the axis 11A of the nozzle 11, and diverts the fire-extinguishing liquid discharged from the nozzle 11 into flows directed toward the first surface 41c11 and the second surface 41c12. Therefore, the fire-extinguishing liquid discharged from the nozzle 11 is diverted into multiple flows by the pressure receiving projection 33h (the first plate portion 33d (first diverting plate piece) and the fourth plate portion 33g (second diverting plate piece)), whereby the fire-extinguishing liquid can be appropriately scattered over the protection region.

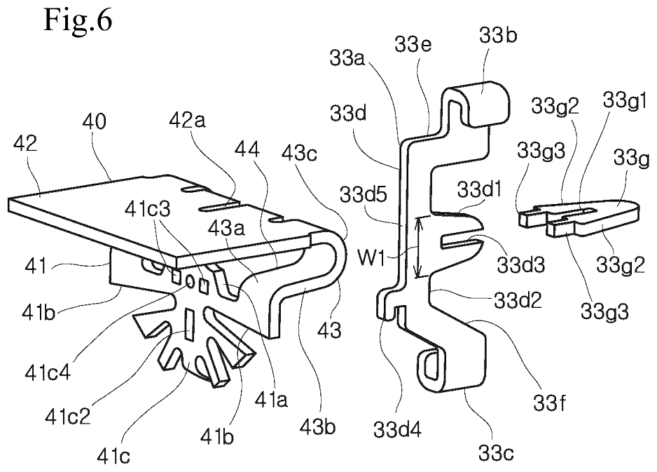

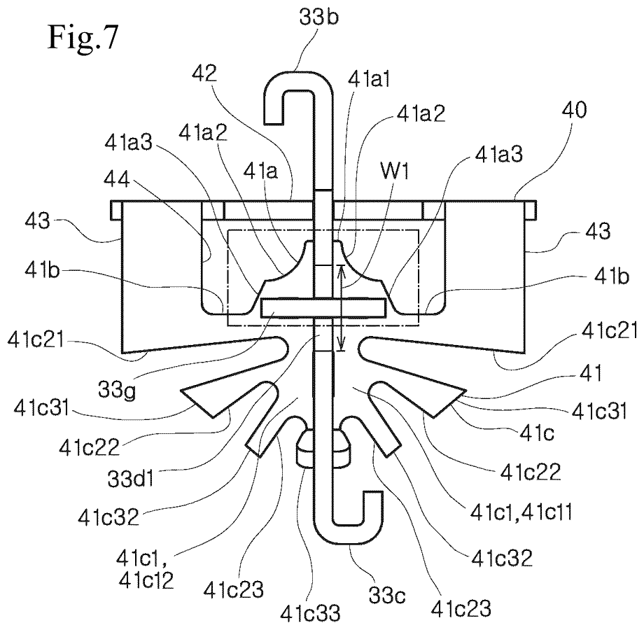

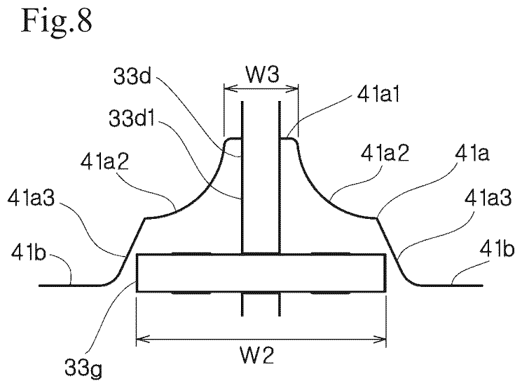

The pressure receiving projection 33h of this embodiment is formed by the first plate portion 33d as the “first diverting plate piece” and the fourth plate portion 33g as the “second diverting plate piece” as described above. That is, the pressure receiving projection 33h functions as a rectifying member for rectifying the flow of fire-extinguishing liquid toward the deflector 40. In this embodiment, the plate width W2 (FIG. 8) of the fourth plate portion 33g is formed wider than the plate width W1 (FIGS. 6 and 7) of the first plate portion 33d. The fire-extinguishing liquid discharged from the nozzle 11 is cylindrical. However, since the plate width W2 is wider than the plate width W1, when the fire-extinguishing liquid is diverted by the pressure receiving projection 33h, it is diverted to become a horizontally elongated ellipsoidal shape (an ellipsoidal shape with the major axis in the horizontal direction). Therefore, the sprinkler head 1 can better disperse the fire-extinguishing liquid toward the left and right in front of it. Note that the present disclosure is not limited to the plate width W2 being wider than W1, and may also include embodiments where the plate width W2 and the plate width W1 are the same, and embodiments where the plate width W2 is narrower than the plate width W1.

The first pin holder 33b is formed as a bent portion formed by bending a metal plate. The bent portion has a concave shape surrounding the outer periphery of the aforementioned pin body 32c.

The second pin holder 33c is formed as a bent portion formed by bending a metal plate. The bent portion has a concave shape surrounding the outer periphery of the aforementioned pin body 32c.

The first pin holder 33b bends to one side centered on the plate thickness of the arm portion 33a. The second pin holder 33c bends to the other side centered on the plate thickness of the arm portion 33a. The first pin holder 33b and the second pin holder 33c are each formed to wrap around the pin body 32c from the outer peripheral surface portion that does not face the center of the axis 11A. Thereby, the first pin holder 33b and the second pin holder 33c can each hold the pair of pin bodies 32c so as to sandwich them from opposite directions and prevent them from coming off the pins 32. Thus, the pair of pin holders (first pin holder 33b, second pin holder 33c) can reliably hold the pair of pins 32 by a holding structure that holds the centers of the pair of pins 32 offset in opposite directions to each other, centered on the plate thickness of the arm portion 33a.

The first pin holder 33b and the second pin holder 33c are formed as angular bent portions in this embodiment, but are not limited to this. That is, in other embodiments, the first pin holder 33b and the second pin holder 33c can also be formed as arcuate bent portions.

The deflector 40 is configured as a plate shaped component. More specifically, the deflector 40 of this embodiment is configured as a press molding body of a metal plate. The metal thin plate can use, for example, one of about 1.5 mm. That is, the deflector 40 can be constituted by a metal plate of the same plate thickness as the arm plate 33.

### Deflector 40

The deflector 40 has, for example, as shown in FIGS. 5 to 7, a deflector main body 41, an assist deflector 42, a connection piece portion 43, and a water flow opening portion 44.

### Deflector Main Body 41

The deflector main body 41 is the base of the deflector 40. The deflector main body 41 is formed as a vertical piece perpendicular to the center of the axis 11A of the nozzle 11. That is, the deflector main body 41 has the plate surface of the metal plate along the vertical direction. As shown in FIG. 7, the deflector main body 41 has a rectifying projection 41a, side projections 41b, and a water spray portion 41c.

The rectifying projection 41a is formed as a mountain-shaped projection as shown in FIGS. 7 to 9. The rectifying projection 41a has a top 41a1, a first foot portion 41a2, and a second foot portion 41a3. The top 41a1 is a tip having a predetermined plate width W3 as shown in FIG. 8. The plate width W3 is formed wider than the plate thickness W4 of the arm plate 33, specifically, the plate width (W4) of the end face (plate edge surface corresponding to the plate thickness) of the deflector side plate end 33d5 of the arm portion 33a (first diverting plate piece). For example, if the plate width W3 is narrower than the plate thickness W4, the fire-extinguishing liquid diverted by the arm portion 33a may easily converge after passing the rectifying projection 41a, and the dispersion directly in front may become excessive. However, as in this embodiment, since the plate width W3 is wider than the plate thickness W4, it can suppress the fire-extinguishing liquid diverted by the arm portion 33a from converging after passing the left and right of the rectifying projection 41a. Further, in this embodiment, the plate width W3 is set to slightly project to the left and right of the plate thickness W4. More specifically, the projection length of the top 41a1 projecting to the left and right of the arm portion 33a can be about half of the plate thickness W4, respectively. This can ensure that the fire-extinguishing liquid diverted by the arm portion 33a is dispersed directly in front and to the front left and right of the rectifying projection 41a. Therefore, it can prevent the necessary dispersion of fire-extinguishing liquid directly in front of the rectifying projection 41a from becoming impossible.

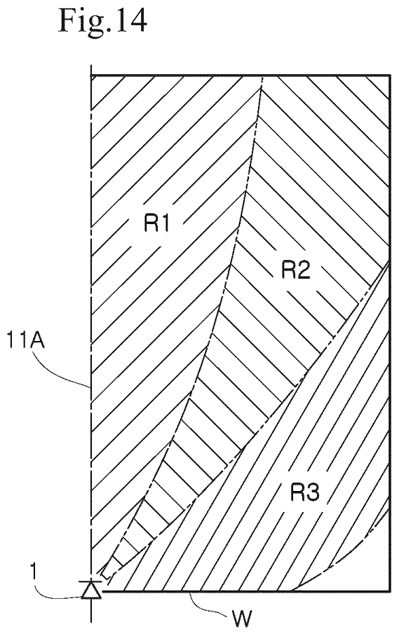

The first foot portion 41a2 is formed as a plate end with a shape where the ridgeline extending from the top 41a1 curves in a concave shape. If the plate end of the first foot portion 41a2 has a linear shape similar to the second foot portion 41a3 instead of a concave curved shape, when the diverted fire-extinguishing liquid hits that portion, the momentum of the flow of the fire-extinguishing liquid would be reduced. In contrast, since the first foot portion 41a2 has a concave curved shape, contact with the diverted fire-extinguishing liquid can be avoided, and the forward flight distance of the sprinkler head 1 can be extended. Specifically, as shown in FIG. 14, the water spray distribution of the first foot portion 41a2 becomes like water spray distribution R1.

The second foot portion 41a3 is formed as a linear plate end substantially directed obliquely downward from the lower end of the first foot portion 41a2. Since the second foot portion 41a3 is a wall projecting more in the horizontal direction compared to the first foot portion 41a2, it can control the direction of dispersion so that the fire-extinguishing liquid will be directed more obliquely forward compared to the first foot portion 41a2. Specifically, as shown in FIG. 14, the water spray distribution R2 of the second foot portion 41a3 becomes such that the fire-extinguishing liquid is dispersed from far positions obliquely forward to near positions.

The side projection 41b is formed as a thin piece projecting to the left and right sides of the rectifying projection 41a. The tip of the side projection 41b is connected to the connection piece portion 43. In other words, the side projection 41b is provided between the rectifying projection 41a and the connection piece portion 43.

The water spray portion 41c is formed in a flat plate shape. The water spray portion 41c has a water sprayed surface 41c1, cutout grooves 41c21, 41c22, 41c23, and vanes 41c31, 41c32, 41c33.

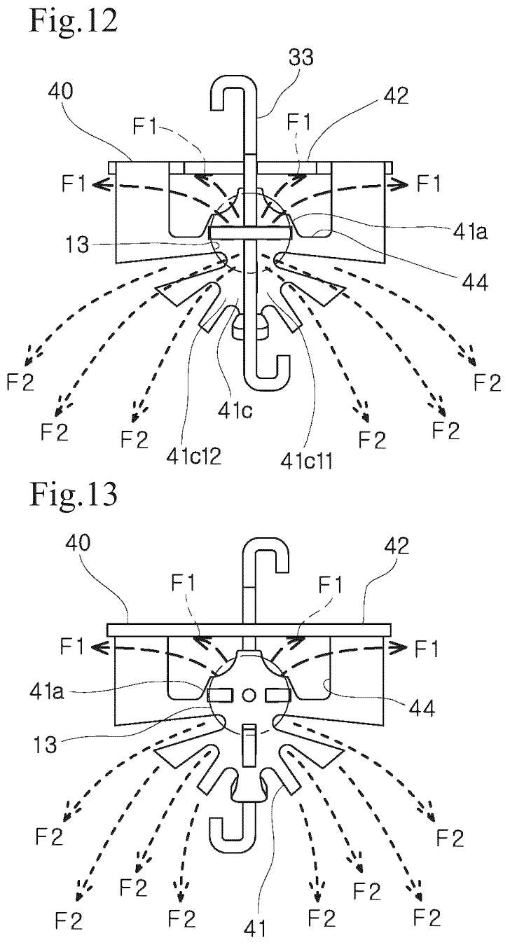

The water sprayed surface 41c1 is a portion with which the fire-extinguishing liquid discharged from the nozzle 11 and diverted by the arm plate 33 comes into contact. As shown in FIG. 12, the fourth plate portion 33g (second diverting plate piece) of the arm plate 33 is arranged so that the plate surface will be horizontal at a position passing through the center of the axis 11A of the nozzle 11, and the water sprayed surface 41c1 is positioned below the fourth plate portion 33g (center of the axis 11A of the nozzle 11). Therefore, the water sprayed surface 41c1 becomes the portion that contacts the fire-extinguishing liquid diverted below the fourth plate portion 33g among the fire-extinguishing liquid discharged from the nozzle 11 and diverted up and down by the fourth plate portion 33g. The water sprayed surface 41c1 is formed separated into a first surface 41c11 and a second surface 41c12 by the arm plate 33 in this embodiment. The fire-extinguishing liquid diverted by the arm plate 33 hits the first surface 41c11 and the second surface 41c12 and scatters.

The water spray portion 41c has a plurality of vanes 41c31, 41c32, 41c33 formed by cutout grooves 41c21, 41c22, 41c23. The surfaces on the nozzle 11 side of the first vane 41c31, the second vane 41c32, and the third vane 41c33 all become elements constituting the water sprayed surface 41c1.

The first vane 41c31 is a flat plate shape (flat vane). That is, the first vane 41c31 has no bent portion. The first vane 41c31 extends obliquely downward and is formed in a shape where the plate width widens from the base end side toward the tip end side. The gap between the first vane 41c31 and the side projection 41b, that is, the cutout groove 41c21, specifically becomes, as shown in FIG. 14, a water spray distribution R3 that disperses the fire-extinguishing liquid at positions even more obliquely forward and near to the sprinkler head 1 than the water spray distribution R2 of the second foot portion 41a3.

The second vane 41c32 is a flat plate shape (flat vane). That is, the second vane 41c32 has no bent portion. The second vane 41c32 extends obliquely downward and is formed in a shape where the plate width tapers from the base end side toward the tip end side.

The third vane 41c33 is a bent shape (bent vane) with the tip side bending toward the nozzle 11 side. Here, when both the second vane 41c32 and the third vane 41c33 are flat plate shapes without bending, the channel for fire-extinguishing liquid (cutout groove 41c23) between the second vane 41c32 and the third vane 41c33 is formed by a two-dimensional gap (first gap) on the same plane. In contrast, when the second vane 41c32 is a flat plate shape and the third vane 41c33 is a bent shape, the second vane 41c32 and the third vane 41c33 have a twisted spatial relationship. Therefore, the channel for fire-extinguishing liquid (cutout groove 41c23) formed between their opposing plate ends becomes a three-dimensional shaped channel formed by a three-dimensional gap. This can form a larger gap compared to the first gap, allowing more fire-extinguishing liquid to pass through easily, and effectively scattering the fire-extinguishing liquid to the close protection region obliquely forward and below the sprinkler head 1.

Further, the third vane 41c33 is a bent shape that bends toward the nozzle 11 side. The fire-extinguishing liquid that hits the water sprayed surface 41c1 tends to fall downward along the water sprayed surface 41c1. However, since the third vane 41c33 is bent toward the nozzle 11 side, the water flow falling along the water sprayed surface 41c1 can be returned to the nozzle 11 side along that bending. This allows a certain amount of fire-extinguishing liquid to be sprayed on the sidewall W where the sprinkler head 1 is installed.

Although an example was shown where the third vane 41c33 is substantially bent over its entire length, it is not limited to this and may be a combination of a flat plate shape and a bent shape.

Furthermore, as shown in FIG. 6, a first mounting receiver portion 41c2, a second mounting receiver portion 41c3, and a contact receiver portion 41c4 are formed in the water spray portion 41c.

The first mounting receiver portion 41c2 is a portion where the first mounting portion 33d4 of the arm plate 33 is mounted. The first mounting receiver portion 41c2 is formed as a rectangular hole through which the plate thickness of the first mounting portion 33d4 of the arm plate 33 can be inserted.

The second mounting receiver portion 41c3 is a portion where the pair of second mounting portions 33g3 of the aforementioned fourth plate portion 33g (boss plate) are mounted. The second mounting receiver portions 41c3 are provided as a pair above the first mounting receiver portion 41c2. The second mounting receiver portion 41c3 is formed as a rectangular hole through which the second mounting portion 33g3 can be inserted.

To obtain an assembly of the arm plate 33 and the deflector 40, the following is performed.

For the arm plate 33, the first mounting portion 33d4 is inserted through the first mounting receiver portion 41c2, and the first plate portion 33d is inserted through the arm plate slit 42a (FIG. 6) of the assist deflector 42 described later. Then, by lowering the arm plate 33 downward relative to the deflector 40, the locking claw of the first mounting portion 33d4 engages with the edge of the first mounting receiver portion 41c2. This prevents the arm plate 33 from coming off from the deflector 40.

Subsequently, with the slit 33g1 of the fourth plate portion 33g fitted to the slit 33d3 of the first plate portion 33d, after the pair of second mounting portions 33g3 are each inserted through the corresponding second mounting receiver portions 41c3, they are bent into a hook shape. Then, the second mounting portion 33g3 has its locking claw bent into a hook shape engaging with the plate edge of the second mounting receiver portion 41c3. This prevents the fourth plate portion 33g from coming off from the deflector 40 with the arm plate 33 sandwiched between the deflector 40 and the fourth plate portion 33g.

Thus, since the arm plate 33 as the “first diverting plate piece” has the first mounting portion 33d4 for mounting to the deflector 40, and the deflector 40 has the first mounting receiver portion 41c2 for mounting the first mounting portion 33d4, the arm plate 33 and the deflector 40 can be configured as an integral assembly. Since the fourth plate portion 33g as the “second diverting plate piece” has the second mounting portion 33g3 for mounting to the deflector 40, and the deflector 40 has the second mounting receiver portion 41c3 for mounting the second mounting portion 33g3, the fourth plate portion 33g as the “second diverting plate piece” can be configured as an integral assembly with the deflector 40.

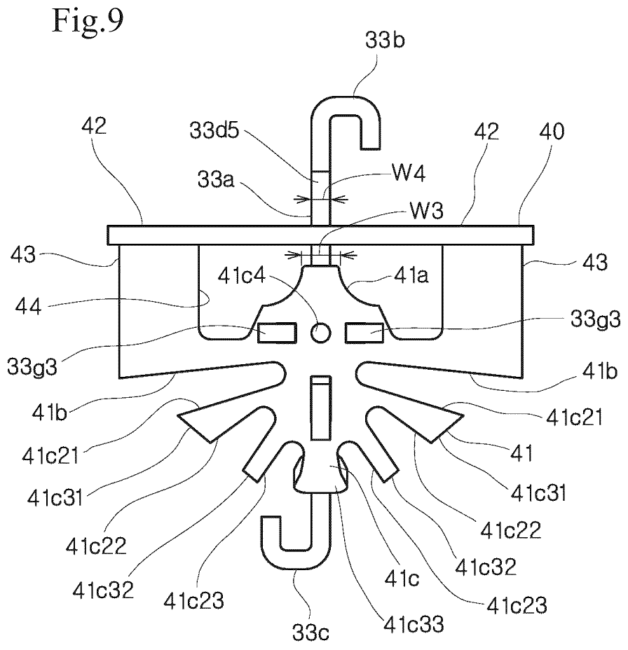

As shown in FIGS. 6 and 9, a contact receiver portion 41c4 is formed between the pair of second mounting receiver portions 41c3. The contact receiver portion 41c4 is formed as a circular depression, but is not limited to this and may be a through-hole.

### <Assist Deflector 42>

The assist deflector 42 is supported by the deflector main body 41 via a pair of connection piece portions 43. The assist deflector 42 is formed in a flat plate shape. More specifically, the assist deflector 42 is a polygonal flat plate shape, and a pair of connection piece portions 43 (second bent portions 43c) are connected to its main body side plate edge. Thereby, the assist deflector 42 is disposed above the deflector main body 41 and is supported by the deflector main body 41 via the connection piece portions 43. An arm plate slit 42a is formed in the main body side plate edge of the assist deflector 42. The arm plate slit 42a is provided as a cutout groove formed in the flat plate-shaped assist deflector 42 and has a groove width corresponding to the plate width of the arm plate 33. The arm plate 33 (deflector side plate end 33d5) is inserted here. By combining the arm plate 33 with the assist deflector 42 in this way, the positions of the assist deflector 42 and the arm plate 33 can be fixed so that they will not deform left and right when receiving external forces.

### <Connection Piece Portion 43>

The pair of connection piece portions 43 each have a first bent portion 43a, an intermediate portion 43b, and a second bent portion 43c.

The first bent portion 43a is a portion that bends from the upper edge of the connection piece portion 43 toward the main body 10. The first bent portion 43a bends substantially at a right angle so that its plate surface will changes from the vertical direction to along the horizontal direction. The intermediate portion 43b is a portion provided between the first bent portion 43a and the second bent portion 43c. The intermediate portion 43b extends in the horizontal direction without substantially inclining. Therefore, compared to a configuration where the intermediate portion 43b extends and incline upward, the entire deflector 40 can be configured compactly in the height direction. When the deflector 40 is made compact in the height direction, the gap between the assist deflector 42 and the side projection 41b in the water flow opening portion 44 can be narrowed. This can increase the flow velocity of the fire-extinguishing liquid F1 flowing along the lower surface of the assist deflector 42, making it easier to extend the forward flight distance of the fire-extinguishing liquid. The second bent portion 43c is a portion that bends in a semi arc-shaped or U-shaped, and its upper end is connected to the assist deflector 42.

### <Water Flow Opening Portion 44>

The water flow opening portion 44 is a portion through which the fire-extinguishing liquid that is scattered mainly to the protection region in front of the sprinkler head 1 flows. The water flow opening portion 44 is a portion formed by the plate edges of the deflector main body 41, the assist deflector 42, and the pair of connection piece portions 43.

### Heat-Sensitive Member 50

The heat-sensitive member 50 supports the closing load of the valve body 14 during normal times when no fire is detected, and has a function of operating the sprinkler head 1 by unloading the closing load of the valve body 14 when it detects the heat of fire.

The heat-sensitive member 50 is supported by the frame 20. Specifically, the heat-sensitive member 50 is supported by the frame 20 via a pair of levers 51. Each lever 51 is formed in a bar shape. Each lever 51 has its first end (outer end on the frame 20 side) engaged with the step 21 of the frame 20. Each lever 51 has its second end (inner end on the heat-sensitive member 50 side) engaged with a hole formed in the heat-sensitive member 50. The heat-sensitive member 50 is disposed projecting beyond the open end 22 of the frame 20 to the outside of the frame 20. A saddle 52 and a screw 53 are installed between the pair of levers 51 and the valve body 14.

As shown in FIG. 3, the saddle 52 is formed in a bar shape with a U-shaped cross section. Therefore, a groove extending in the horizontal direction is formed inside the U shape of the saddle 52. As shown in FIG. 2, the pair of levers 51 are arranged in the groove of the saddle 52. A threaded hole 52a having a female thread is formed in the center of the saddle 52, and the screw 53 is screwed into the threaded hole 52a as shown in FIG. 3. As shown in FIG. 3, when the screw 53 inserted into the threaded hole 52a is screwed toward the valve body 14, the screw 53 abuts the deflector 40 (the contact receiver portion 41c4 of the deflector main body 41 (see FIG. 6)), and the deflector 40 presses the pressure receiving projection 33h of the arm plate 33 toward the nozzle 11. This supports the valve body 14 while it closes the outlet of the nozzle 11 in a liquid-tight state. At the same time, the lever 51 accommodated inside the saddle 52 is pressed by the saddle 52, and a force acts on the lever 51 to rotate the link-side end of the lever 51 (inner end on the heat-sensitive member 50 side) in a direction away from each other with the engagement portion with the step 21 as a fulcrum.

The heat-sensitive member 50 is a link formed by bonding two thin metal plates with a fusible alloy. When the fusible alloy melts due to the heat of fire, the lever 51 rotates due to the force applied from the aforementioned saddle 52 to the lever 51, the two metal plates peel apart, and the lever 51 comes off from the frame 20. This causes the valve body 14 to separate from the outlet 13 of the nozzle 11 and the fire-extinguishing liquid is discharged.

### Urging Member 60

As shown by the change in FIGS. 3 and 4, the urging member 60 pushes the guide ring 31 toward the open end 22 of the frame 20 to move the guide ring 31 when the sprinkler head 1 operates. The urging member 60 exemplifies a compression coil spring in this embodiment, but other springs may be used. The compression coil spring exemplified here is a conical spring, but other springs may be used. As shown in FIG. 3, the conical spring can be accommodated in a slight gap between the main body 10 and the guide ring 31 in a compressed state where the wire rod of the coil does not overlap during normal times of the sprinkler head 1. This can contribute to miniaturization in the direction of the center of the axis 11A of the sprinkler head 1.

As shown in FIGS. 3 and 4, a first end 61 on the main body 10 side of the conical spring which is the urging member 60 has an inner diameter that can be arranged along the outer periphery of the cylindrical outlet 13 of the nozzle 11. This allows the conical spring and the center of the axis 11A of the nozzle 11 to substantially coincide, preventing biased urging of the guide ring 31 due to position deviation of the central axis of the conical spring. Further, by preventing position deviation of the first end 61, position deviation of a second end 62 on the guide ring 31 side is also prevented.

### Cover Member 70

As shown in FIG. 3, the cover member 70 has a function of covering and hiding the opening Wh provided in the sidewall W of the building. Specifically, the cover member 70 has a retainer 71 and a cover plate 72.

The retainer 71 has a tubular portion 71a and a flange portion 71b. The tubular portion 71a has a cylindrical shape and is mounted on the outer periphery of the frame 20 and held by the frame 20. The flange portion 71b is annular and is a portion that abuts against the sidewall W when the sprinkler head 1 including the cover member 70 is installed on the sidewall W. When the flange portion 71b abuts against the sidewall W, a gap is formed between the sidewall W and the cover plate 72 for taking in hot air during fire, thereby positioning the cover plate 72.

The flange portion 71b has leg portions 71c at multiple locations (for example, three locations) on its circumference, formed by partially cutting and raising the metal plate of the flange portion 71b. The leg portion 71c has a vertical piece directed toward the cover plate 72 and a horizontal piece that is bent relative to the vertical piece and fixed to the back surface of the cover plate 72 (both not shown). When the horizontal piece of the leg portion 71c is fixed to the back surface of the cover plate 72, the retainer 71 and the cover plate 72 become integral, constituting the cover member 70. The horizontal piece of the leg portion 71c is fixed to the cover plate 72 by a fusible alloy that operates at a lower operation temperature than the fusible alloy used for the link of the heat-sensitive member 50.

The cover plate 72 has a disc-like shape, and arbitrary decoration by color or pattern is applied to the outer surface on the room-side to form a decorated surface.

### Operation of Sprinkler Head 1

Next, the operation of the sprinkler head 1 will be described. When fire occurs, hot air flows between the cover plate 72 and the flange portion 71b of the retainer 71. This causes the fusible alloy fixing the leg portion 71c to the cover plate 72 to soften and melt, causing the cover plate 72 to peel off from the leg portion 71c and fall downward. This exposes the interior of the frame 20 mounted on the inner periphery of the retainer 71 to the room-side of the sidewall W.

Following the softening and melting of the fusible alloy of the leg portion 71c, the heat-sensitive member 50 can disassemble. That is, the fusible alloy fixing the links together softens and melts, causing the links to separate. This causes the lever 51 to come off from the frame 20 as described above, and the heat-sensitive member 50, the saddle 52, and the screw 53 lose support by the lever 51 relative to the frame 20. Along with this, the compression coil spring that was compressed and stored, that is, the urging member 60, restores, causing the guide ring 31 to be pushed by the urging member 60 toward the open end 22. The guide ring 31 moves to the step 21 of the frame 20 while its guide receiver portion 31d receives guidance from the guide portion 23 of the frame 20. Therefore, the guide ring 31 can move smoothly to the step 21.

The valve body 14 that was sealing the outlet 13 of the nozzle 11 receives the pressure of the fire-extinguishing liquid and is pushed toward the open end 22 of the frame 20. This causes the valve body 14 to press the pressure receiving projection 33h (the first plate portion 33d and the fourth plate portion 33g of the arm plate 33), and the arm plate 33 moves toward the open end 22 of the frame 20. At this time, the movement of the first pin holder 33b and the second pin holder 33c is guided by the pins 32 along the longitudinal direction of the pins 32, respectively. The arm plate 33 moves until the first pin holder 33b and the second pin holder 33c abut the preventive portions 32b. In this way, the arm plate 33 moves from the normal state in FIG. 3 to the operating state shown in FIG. 4.

As a result, as shown in FIG. 4, the arm plate 33 and the deflector 40 are arranged projecting from the opening Wh of the sidewall W to the room-side. Therefore, the sprinkler head 1 can disperse the fire-extinguishing liquid discharged from the nozzle 11 at a position close to the protection region.

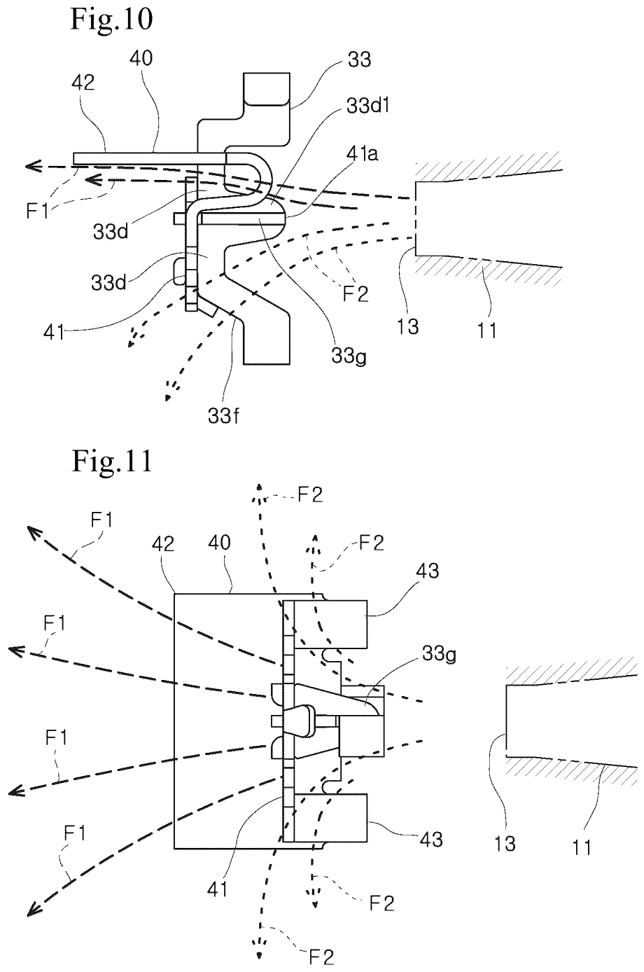

### Water Spray Operation of Fire-Extinguishing Liquid by Sprinkler Head 1 (FIGS. 10-13)

The fire-extinguishing liquid is discharged from the outlet 13 of the nozzle 11 in a cylindrical shape. This is because the outlet 13 is tubular. The cylindrical fire-extinguishing liquid hits the pressure receiving projection 33h. The vertex of the pressure receiving projection 33h is positioned on the center of the axis 11A of the nozzle 11, and the pressure receiving projection 33h has a cross shape. Since the first plate portion 33d and the fourth plate portion 33g constituting this pressure receiving projection 33h have plate edge surfaces that contact the fire-extinguishing liquid in a plate piece shape, the contact area with the fire-extinguishing liquid is small, and reduction in the momentum of the flow can be suppressed even when the fire-extinguishing liquid hits them.

Seen from the flow of fire-extinguishing liquid from the outlet 13 side of the nozzle 11 toward the pressure receiving projection 33h, the cylindrical fire-extinguishing liquid is diverted by the pressure receiving projection 33h into an upper flow F1 and a lower flow F2 as shown in FIG. 10. At the same time, the upper flow is further diverted into left and right flows by the projecting portion 33d1 and the first plate portion 33d (vertical arm piece) of the arm plate 33. The lower flow is further diverted into left and right flows by the projecting portion 33d1 and the third plate portion 33f (inclined arm piece) of the arm plate 33.

The upper flow of the fire-extinguishing liquid hits the first plate portion 33d as the “vertical arm piece”. The first plate portion 33d extends upward vertically to the center of the axis 11A. The water column-shaped (upper semi-cylindrical) fire-extinguishing liquid flows forward while being diverted to the left and right of the first plate portion 33d by contacting the first plate portion 33d. The fire-extinguishing liquid diverted to the left and right passes through the water flow opening portion 44 while being rectified by the rectifying projection 41a of the deflector 40, and its flow velocity is increased (see the explanation items for the aforementioned rectifying projection 41a and connection piece portion 43). After that, the fire-extinguishing liquid slides along the lower surface while receiving guidance from the lower surface of the assist deflector 42, and is sprayed from the tip of the assist deflector 42 toward the forward protection region. For example, when the protection region is divided into a far region, an intermediate region, and a near region according to the distance from the sprinkler head 1, the fire-extinguishing liquid is mainly sprayed in the far region and the intermediate region.

On the other hand, the lower flow of the fire-extinguishing liquid hits the third plate portion 33f as the “inclined arm piece”. The third plate portion 33f extends obliquely downward in a direction approaching from the deflector 40 side toward the main body 10 side. The tip of the water column-shaped (lower semi-cylindrical) fire-extinguishing liquid gradually contacts from the lower end side (main body 10 side) to the upper end side (deflector 40 side) of the third plate portion 33f as the “inclined arm piece”. In other words, the water column gradually contacts the third plate portion 33f from its outer peripheral surface side toward the center side. As a result, the outer peripheral surface side of the water column of the fire-extinguishing liquid scatters forward and downward, and the forward flight distance can be gradually extended from the outer peripheral surface side toward the center side of the water column. In this way, the third plate portion 33f as the “inclined arm piece” can gradually divert the fire-extinguishing liquid to the left and right of its plate thickness. Then, the fire-extinguishing liquid that has contacted the third plate portion 33f contacts the water sprayed surface 41c1 (first surface 41c11, second surface 41c12) of the water spray portion 41c of the deflector 40, is rectified by the water spray portion 41c (cutout grooves 41c21 to 41c23, first vane 41c31, second vane 41c32, third vane 41c33), and is sprayed forward. The fire-extinguishing liquid is mainly sprayed in the intermediate region and the near region.

### Effects of Sprinkler Head 1

The sprinkler head 1 comprises: a main body 10 having a nozzle 11 for discharging fire-extinguishing liquid; a valve body 14 for closing the outlet 13 of the nozzle 11; a deflector 40 having a water sprayed surface 41c1 with which the fire-extinguishing liquid discharged from the nozzle 11 comes into contact; and an arm plate 33 as a “first diverting plate piece” supporting the deflector 40. The arm plate 33 has a plate piece shape with its plate surface rising vertically from the water sprayed surface 41c1 toward the main body 10, divides the water sprayed surface 41c1 into a plurality of surfaces, and diverts the fire-extinguishing liquid into flows directed toward the plurality of surfaces.

Since the arm plate 33 supporting the deflector 40 has a plate piece shape, when the fire-extinguishing liquid discharged from the nozzle 11 contacts the arm plate 33, reduction in the momentum of the flow of the fire-extinguishing liquid can be suppressed. The arm plate 33 divides the water sprayed surface 41c1 into a plurality of surfaces and diverts the fire-extinguishing liquid into flows directed toward the plurality of surfaces. Therefore, by diverting the fire-extinguishing liquid while maintaining the momentum of the fire-extinguishing liquid discharged from the nozzle 11 as much as possible, the fire-extinguishing liquid can be appropriately dispersed over the protection region.

### Modifications of the Embodiment

In the above embodiment, the sidewall sprinkler head 1 was exemplified, but it may be modified to a sprinkler head not installed on a sidewall. That is, the sprinkler head of the present disclosure is not limited to a sidewall type. The problem of appropriately dispersing fire-extinguishing liquid over the protection region may also apply to upward-type sprinkler heads and downward-type sprinkler heads. In an upward-type sprinkler head, the fire-extinguishing liquid discharged upward from the nozzle is scattered in the horizontal direction by the deflector. In a downward-type sprinkler head, the fire-extinguishing liquid discharged downward from the nozzle is scattered in the horizontal direction by the deflector. In either of these cases, there is a risk that the fire-extinguishing liquid may hit the support member and fail to secure the flight distance covering the protection region. However, the sprinkler head 1 of the above embodiment can be applied to upward-type or downward-type by changing the shape of its deflector.

In the above embodiment, a concealed type sidewall sprinkler head 1 having a cover member 70 was exemplified, but it may be one without the cover member 70. That is, the sprinkler head of the present disclosure is not limited to a concealed type.

Reference Signs List

1 SPRINKLER HEAD, 10 MAIN BODY, 11 NOZZLE, 11A CENTER
OF THE AXIS, 13 OUTLET, 14 VALVE BODY, 30 SUPPORT MEMBER, 31
GUIDE RING, 32 PIN (GUIDE PIN), 33 ARM PLATE, 33a ARM
PORTION (FIRST DIVERTING PLATE PIECE), 33b FIRST PIN HOLDER,
33c SECOND PIN HOLDER, 33d FIRST PLATE PORTION (VERTICAL ARM
PIECE), 33d1 PROJECTING PORTION, 33d4 FIRST MOUNTING
PORTION, 33e SECOND PLATE PORTION (HORIZONTAL ARM PIECE),
33f THIRD PLATE PORTION (INCLINED ARM PIECE), 33g FOURTH
PLATE PORTION (SECOND DIVERTING PLATE PIECE), 33g3 SECOND
MOUNTING PORTION, 33h PRESSURE RECEIVING PROJECTION, 40
DEFLECTOR, 41 DEFLECTOR MAIN BODY, 41a RECTIFYING
PROJECTION, 41c WATER SPRAY PORTION, 41c1 WATER SPRAYED
SURFACE, 41c11 FIRST SURFACE, 41c12 SECOND SURFACE, 41c2
FIRST MOUNTING RECEIVER PORTION, 41c3 SECOND MOUNTING
RECEIVER PORTION, 42 ASSIST DEFLECTOR, 44 WATER FLOW OPENING
PORTION, 50 HEAT-SENSITIVE MEMBER, 70 COVER MEMBER, W
SIDEWALL, Wh OPENING

1. A sprinkler head comprising:
a main body having a nozzle for discharging fire-extinguishing liquid;
a valve body for closing an outlet of the nozzle;
a deflector having a water sprayed surface with which the fire-extinguishing liquid discharged from the nozzle comes into contact; and
a first diverting plate piece supporting the deflector,
wherein the first diverting plate piece has a plate piece shape with its plate surface rising vertically from the water sprayed surface toward the main body,
wherein the first diverting plate divides the water sprayed surface into a plurality of surfaces, and
wherein the first diverting plate diverts the fire-extinguishing liquid into flows directed toward the plurality of surfaces.

2. The sprinkler head according to claim 1, wherein the first diverting plate piece has a first mounting portion for mounting to the deflector, and
wherein the deflector has a first mounting receiver portion for mounting the first mounting portion.

3. The sprinkler head according to claim 1, wherein the first diverting plate piece has a projecting portion that projects toward the valve body and that receives a closing load of the valve body against the nozzle.

4. The sprinkler head according to claim 1, wherein the first diverting plate piece has an inclined arm piece, and
wherein the inclined arm piece extends obliquely downward in a direction approaching from the deflector side toward the main body side.

5. The sprinkler head according to claim 1, wherein the first diverting plate piece has a vertical arm piece, and
wherein the vertical arm piece extends upward vertically to a center of the axis of the nozzle.

6. The sprinkler head according to claim 1, further comprising a pin for movably supporting the deflector along an axial direction of the nozzle,
wherein the first diverting plate piece has a pin holder movably engaged with the pin.

7. The sprinkler head according to claim 1, further comprising a second diverting plate piece,
wherein the second diverting plate piece has a plate piece shape with its plate surface rising vertically from the water sprayed surface toward the main body in a state intersecting with the first diverting plate piece, and
wherein the second diverting plate piece diverts the fire-extinguishing liquid discharged from the nozzle.

8. The sprinkler head according to claim 7,
wherein at least one of the first diverting plate piece or the second diverting plate piece has a contact portion that abuts the valve body and that receives the closing load of the valve body against the nozzle.

9. The sprinkler head according to claim 7, wherein the second diverting plate piece has a second mounting portion for mounting to the deflector, and
wherein the deflector has a second mounting receiver portion for mounting the second mounting portion.

10. The sprinkler head according to claim 7, wherein the first diverting plate piece and the second diverting plate piece are each formed from a metal plate and constitute a cross-lap joint assembly.

11. The sprinkler head according to claim 10, wherein the first diverting plate piece and the second diverting plate piece have semicircular shapes, and
wherein a maximum plate width of the second diverting plate piece is formed wider than a maximum plate width of the first diverting plate piece.

12. The sprinkler head according to claim 1, wherein the deflector has
a plate-shaped deflector main body vertical to the center of the axis of the nozzle;
an assist deflector disposed above the deflector main body;
a connection piece portion connecting the deflector main body and the assist deflector; and
a water flow opening portion formed between the deflector main body, the assist deflector, and the connection piece portion.

13. The sprinkler head according to claim 12, wherein the deflector main body has a rectifying projection projecting toward the water flow opening portion, and
wherein the rectifying projection has a top wider than a plate thickness of a deflector-side plate end of the first diverting plate piece, and a foot portion where a ridgeline extending from the top curves in a concave shape.
